(19) United States
(12) Patent Application Publication
(10) Pub. No.: US 2021/0169052 A1
(43) Pub. Date: Jun. 10, 2021

(54) AUTOMATICALLY SINKING CAGE NET SYSTEM

(71) Applicant: NATIONAL TAIWAN OCEAN UNIVERSITY, Keelung City (TW)

(72) Inventors: CHUNG-CHENG CHANG, KEELUNG CITY (TW); CHEN-CHOU LIN, TAIPEI CITY (TW); YI-ZENG HSIEH, KEELUNG CITY (TW); CHANG-TA LIN, YILAN COUNTY (TW); ZHEN-YAO CHEN, NEW TAIPEI CITY (TW)

(21) Appl. No.: 17/110,680

(22) Filed: Dec. 3, 2020

(30) Foreign Application Priority Data
Dec. 5, 2019 (TW) 108144582

(51) Int. Cl. A01K 61/65; B63B 35/44; G01C 13/00

(52) U.S. Cl. CPC A01K 61/65; G01C 13/00; B63B 35/44

(57) ABSTRACT

The present disclosure relates to an automatically sinking cage net system, comprising: the cage net body includes a floating frame and a net body; a working platform including an accelerometer, a first processing module and a first wireless communication module; a floating barrel, at least having a first opening, a gas flow controller, a water level sensor, a programmable control module, a second processing module, a second wireless communication module and a second opening; and a marine environment monitoring system, including a human-machine interface, a marine environment monitoring module, a data storage module, a third processing module, and a third wireless communication module; wherein the first wireless communication module, the second wireless communication module and the third wireless communication module are in signal connection with each other. The present disclosure provides an automatically sinking cage net system to improve the conventional shortcomings caused by manual operation.

### TECHNICAL FIELD

The present disclosure relates to an automatically sinking cage net system. By means of a cage net body, a working platform, a floating barrel and a marine environment monitoring system, the cage net body is operated automatically to sink, and the marine environment can be monitored in real time, which significantly reduces the manpower, time and problems caused by manual operation when sinking the cage net body.

### RELATED ART

With the rapid expansion of the global population, the rate of consumption of edible aquatic products has accelerated with the increase in the total population. In addition, in recent years, due to the overfishing of fish, the pollution of the marine environment and the impact of global climate change, natural fishery resources are increasingly scarce, and in order to make up for the huge demand for edible aquatic products, the global aquaculture fisheries rapidly grows.

In fact, due to the small land area of Taiwan, the onshore fish farming industry is not only unable to meet domestic demand, but also the over-pumping of groundwater for the development of onshore fish farms will cause a lot disadvantages, such as ground subsidence. Therefore, the cage net aquaculture industry in open seas has gradually received attention, and in order to prevent the destruction of the cage net due to typhoon surges, the sinking cage net is proposed. See FIG. 1 which shows a conventional sinking cage net, and the conventional sinking cage net comprises a mesh bag (A), a frame (B) and an annular hollow tube (C). The mesh bag (A) is a fully enclosed bag body, the frame (B) is made of a sink body, the mesh bag (A) is fastened to the frame (B), and the annular hollow tube (C) surrounds the frame (B), as shown in FIG. 2. The conventional sinking cage net requires a lot of manpower and time to perform the sinking action of the sinking cage net. In addition, when the sinking cage net sinks, if the sinking cage net is subjected to different directions of gravity, it is easy to make the frame (B) tilt angle be too large, which causes the mesh bag (A) to quickly reduce the volume. When the fish movement space is reduced, the fish are easily injured by collision. In addition, the conventional sinking cage net is not equipped with a monitoring system, and it is impossible to know the relevant information near the water area in time to deal with the temporary potential crisis, or it is difficult to judge the timing of the rise of the conventional sinking cage net.

Therefore, how to use innovative hardware design to effectively improve the manpower and time required for sinking of the conventional sinking cage net, the fish injuries caused by the excessive tilt angle of the frame (B), and the lack of the monitoring system which is unable to collect and analyze marine environment-related data to cope with various situations and other problems at any time, is an important issue that related industry developers and related researchers need to continuously strive to overcome and solve.

### SUMMARY

Accordingly, the conventional sinking cage net is not equipped with a monitoring system and needs to be operated manually. It is time-consuming and labor-intensive during the operation, and when the conventional sinking cage sinks, the tilt angle of the frame is often large to cause fish to be injured due to collisions. There are still many innovations and improvements in the actual implementation of the conventional sinking cage net. Therefore, the Applicant has improved it with the help of his rich professional knowledge and practical experience, and developed the present disclosure accordingly.

A main objective of the present disclosure is to provide an automatically sinking cage net system, which comprises: a cage net body comprising a floating frame and a net body, the net body surrounds a lower end of the floating frame, and the net body surrounds to form breeding space; a working platform comprising an accelerometer, a first processing module and a first wireless communication module, the working platform is disposed on an upper end of the floating frame, and the accelerometer, the first processing module and the first wireless communication module are electrically connected to each other; a floating barrel at least comprising an first opening, a gas flow controller, a water level sensor, a programmable control module, a second processing module, a second wireless communication module and a second opening, interior of the floating barrel has a receiving space, the receiving space is communicated with the first opening and the second opening, the floating barrel is disposed on a lower end of the floating frame and outside the breeding space, the first opening is disposed on one side of the floating barrel, the second opening is disposed on another one side of the floating barrel which is opposite to the first opening, and the gas flow controller, the water level sensor, the programmable control module, the second processing module and the second wireless communication module are electrically connected to each other; and a marine environment monitoring system comprising a human-machine interface, a marine environment monitoring module, a data storage module, a third processing module and a third wireless communication module, the human-machine interface, the marine environment monitoring module, the data storage module, the third processing module and the third wireless communication module are electrically connected to each other, and the first wireless communication module, the second wireless communication module and the third wireless communication module are signally connected to each other.

In one embodiment of the automatically sinking cage net system, the floating frame further has a floating tube surrounding the floating frame, the floating tube forms a ring structure, and interior of the floating tube has a hollow receiving space.

In one embodiment of the automatically sinking cage net system, an upper end of the floating frame has an armrest.

In one embodiment of the automatically sinking cage net system, exterior of the floating barrel further has a propeller.

In one embodiment of the automatically sinking cage net system, the automatically sinking cage net system further comprises an anchor device which includes an anchor, a connection part and a float.

In one embodiment of the automatically sinking cage net system, the connection part is a cable or chain

In one embodiment of the automatically sinking cage net system, the gas flow controller is a thermal gas mass flow controller.

In one embodiment of the automatically sinking cage net system, the water level sensor is a water pressure sensor.

In one embodiment of the automatically sinking cage net system, the marine environment monitoring module further comprises at least one of a wave sensor, a water temperature sensor, a water quality sensor, and a wind speed sensor.

In one embodiment of the automatically sinking cage net system, the human-machine interface comprises a floating barrel status unit, an operation unit and a parameter setting unit.

In one embodiment of the automatically sinking cage net system, the automatically sinking cage net system further comprises a cloud server

In one embodiment of the automatically sinking cage net system, the marine environment monitoring system further comprises a data analysis module, and the human-machine interface comprises a data analysis unit.

In one embodiment of the automatically sinking cage net system, exterior of the floating barrel further has a camera device, and the human-machine interface comprises an image unit.

In one embodiment of the automatically sinking cage net system, the automatically sinking cage net system further comprises a counterweight system, and the counterweight system is disposed on another one side of the net body opposite to the floating frame.

In one embodiment of the automatically sinking cage net system, the counterweight system is selected one of a heavy hammer counterweight structure and a net frame counterweight structure.

Accordingly, the present disclosure provides an automatically sinking cage net system comprising a cage net body, a working platform, a floating barrel, a marine environment monitoring system and a counterweight system, which can significantly reduce the manpower and time required to perform the sinking of the cage net body, and reduce personnel safety issues caused by manual operations. Further, by using the accelerometer to adjust the balance of cage net body to narrow the tilt angle range of cage net body, the problem of rapid decrease in net body volume can be reduced. By providing a marine environment monitoring system, sensors monitor the marine environment and send back relevant monitoring data to assist fishery farmers in the face of sudden natural disasters or accidents, and have a basis to determine when the cage net body sinks or rises, which can significantly reduce the loss of fishery farmers.

### BRIEF DESCRIPTIONS OF DRAWINGS

FIG. 1 is a schematic diagram showing a conventional sinking cage net.

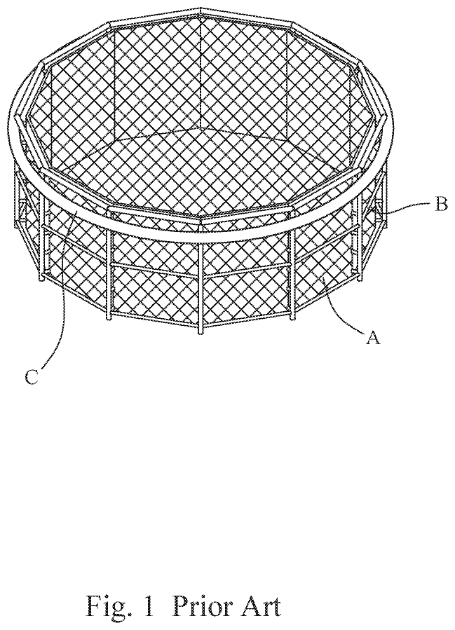

FIG. 2 is a schematic diagram showing operation of a conventional sinking cage net.

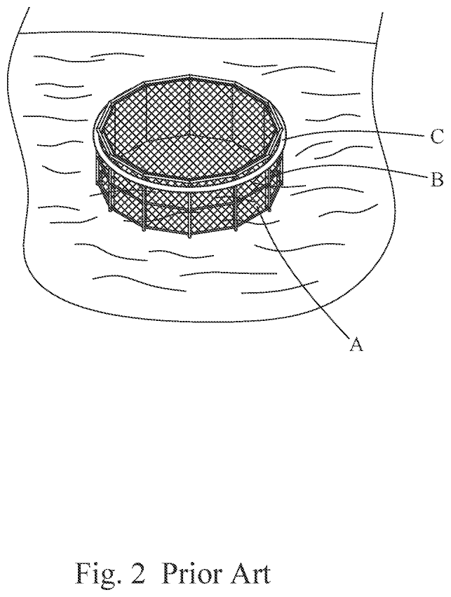

FIG. 3 is an explosive diagram showing an automatically sinking cage net system of the present disclosure.

FIG. 4 is an assembly schematic diagram showing an automatically sinking cage net system of the present disclosure.

FIG. 5 is a block diagram showing an automatically sinking cage net system of the present disclosure.

FIG. 6 is a first schematic diagram showing an automatically sinking cage net system according to one preferred embodiment of the present disclosure.

FIG. 7 is a second schematic diagram showing an automatically sinking cage net system according to one preferred embodiment of the present disclosure.

FIG. 8 is a schematic diagram showing a human-machine interface of an automatically sinking cage net system according to one preferred embodiment of the present disclosure.

FIG. 9 is a schematic diagram showing a heavy hammer counterweight structure of an automatically sinking cage net system according to one preferred embodiment of the present disclosure.

FIG. 10 is a schematic diagram showing a net frame counterweight structure of an automatically sinking cage net system according to one preferred embodiment of the present disclosure.

### DETAILS OF EXEMPLARY EMBODIMENTS

Embodiments of the present disclosure will now be described, by way of example only, with reference to the accompanying drawings. The following drawings are dedicated for description, and they are schematic and exemplary, being not drawn and precisely allocated in accordance with the actual ratio, thus not limiting the present disclosure.

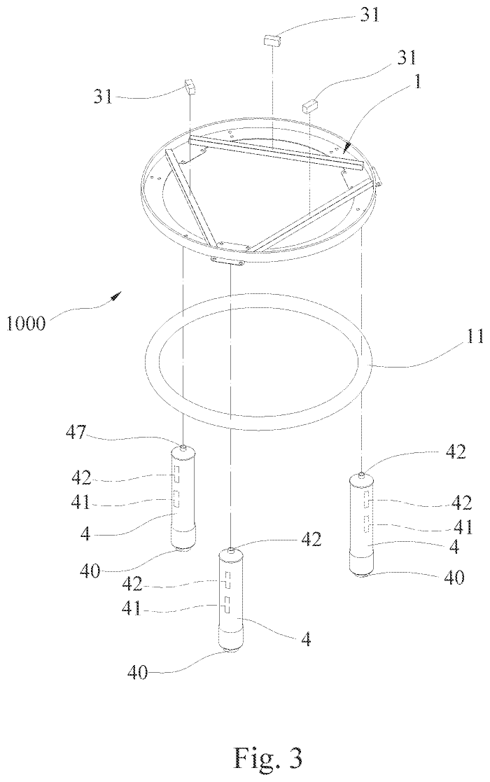

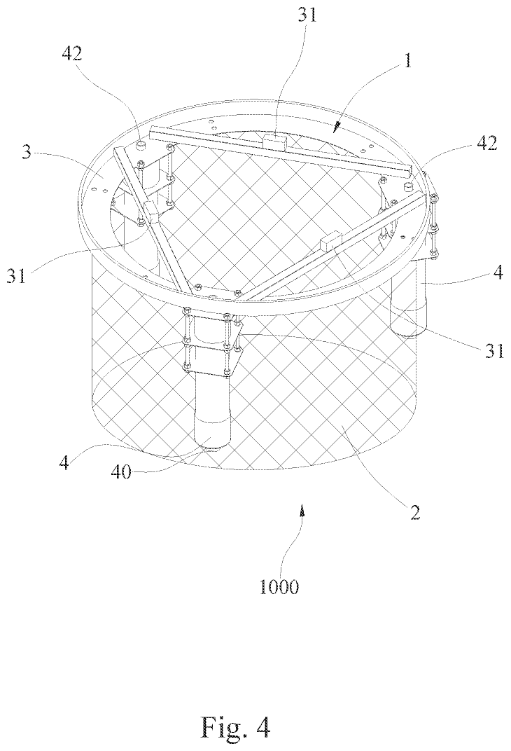

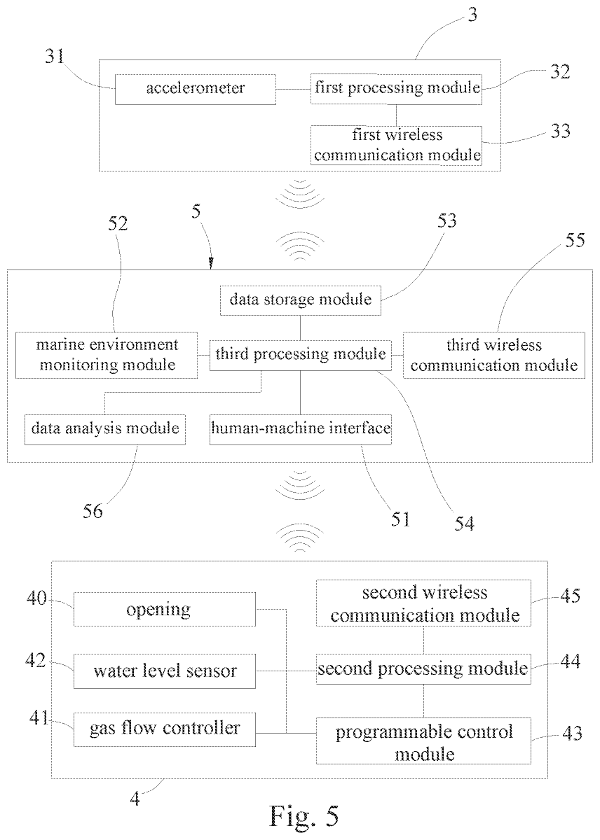

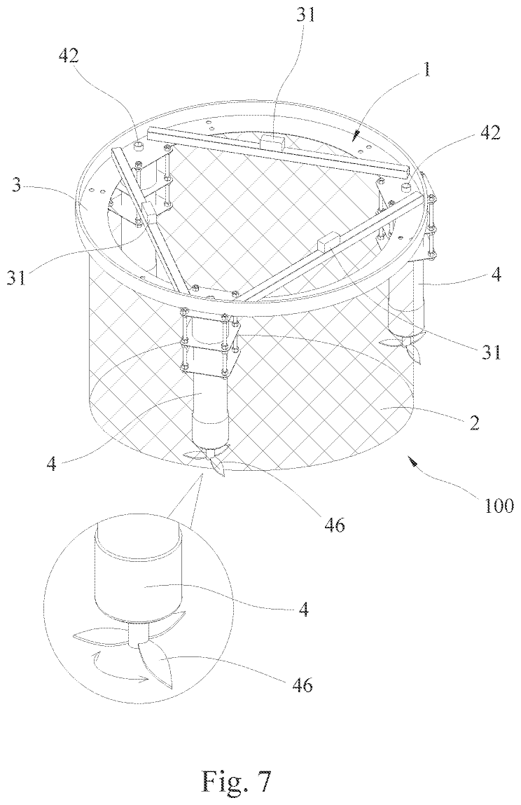

Refer to FIG. 3 through FIG. 7, and they are respectively an explosive diagram, an assembly schematic diagram, a block diagram, a first schematic diagram and a second schematic diagram showing an automatically sinking cage net system according to one preferred embodiment of the present disclosure. The automatically sinking cage net system of the present disclosure at least comprises a cage net body (1000), a working platform (3), at least one floating barrel (4) and a marine environment monitoring system (5).

The cage net body (1000) comprises a floating frame (1) and a net body (2), the net body (2) surrounds a lower end of the floating frame (1), and the net body (2) surrounds to form breeding space. When practicing, the net body (2) is used to prevent the fish in the breeding space from escaping. In one embodiment of the present disclosure, the floating frame (1) further comprises a floating tube (11) surrounding the floating frame (1), the floating tube (11) forms a ring structure, and interior of the floating tube (11) has a hollow receiving space. Each floating tube (11) provides buoyancy on the water so that the floating frame (1) floats on the surface of the water, which is beneficial for fishery farmers to stand on the floating frame (1) for work. In another one embodiment of the present disclosure, an upper end of the floating frame (1) has an armrest. When the cage net body (1000) is affected by waves or ocean currents and shakes, the fishery farmers can use the armrest to keep standing on the floating frame (1) to perform work to prevent the fishery farmers from falling down due to unstable center of gravity.

The working platform (3) comprises an accelerometer (31), a first processing module (32) and a first wireless communication module (33), the working platform (3) is disposed on an upper end of the floating frame (1), and the accelerometer (31), the first processing module (32) and the first wireless communication module (33) are electrically connected to each other. When practicing, the accelerometer (31) generates an acceleration signal according to the movement state of a floating barrel (4), and the acceleration signal is transmitted to a marine environment monitoring system (5) and through the first processing module (32) and the first wireless communication module (33), such that the fishery farmers are assisted in judging the movement state of the cage net body (1000) based on the acceleration signal.

The floating barrel (4) at least comprises an first opening (40), a gas flow controller (41), a water level sensor (42), a programmable control module (43), a second processing module (44), a second wireless communication module (45) and a second opening (47). Interior of the floating barrel (4) has a receiving space, the receiving space is communicated with the first opening (40) and the second opening (47), and the floating barrel (4) is disposed on a lower end of the floating frame (1) and outside the breeding space. The first opening (40) is disposed on one side of the floating barrel (4), and the second opening (47) is disposed on another one side of the floating barrel (4) which is opposite to the first opening (40). The gas flow controller (41), the water level sensor (42), the programmable control module (43), the second processing module (44) and the second wireless communication module (45) are electrically connected to each other. In one embodiment of the present disclosure, the floating barrels (4) are respectively arranged at the lower end of the floating frame (1) in an equilateral triangle. In one other embodiment of the present disclosure, exterior of the floating barrel (4) has a propeller (46), and the propeller (46) is used to control the sinking or rising speed of the cage net body (1000) to cope with various sudden situations at any time. In one other embodiment of the present disclosure, the gas flow controller (41) is a thermal gas mass flow controller, which adjusts the speed of the floating barrel (4) when it rises or sinks by controlling the flow of gas. The water level sensor (42) can be a water pressure sensor, when the floating barrel (4) rises or sinks, the water pressure sensor can detect the deep distance between the floating barrel (4) and the sea level, so as to know whether the sinking position of the floating barrel (4) is within the specified position range, or when the parasites are attached to the fish, by detecting the depth of the floating barrel (4) relative to the sea level, the depth of re-sinking can be determined, which can effectively inhibit the growth of the parasites through physical means and reduce the use of drugs for killing parasites.

The marine environment monitoring system (5) comprising a human-machine interface (51), a marine environment monitoring module (52), a data storage module (53), a third processing module (54) and a third wireless communication module (55). The human-machine interface (51), the marine environment monitoring module (52), the data storage module (53), the third processing module (54) and the third wireless communication module (55) are electrically connected to each other, and the first wireless communication module (33), the second wireless communication module (45) and the third wireless communication module (55) are signally connected to each other. When practicing, the marine environment monitoring module (52) collects a monitoring data generated by the floating barrel (4) and the working platform (3) within a breeding region, the monitoring data is stored in the data storage module (53) via the third processing module (54), or by using the human-machine interface (51), the monitoring data is browsed and analyzed, and the fishery farmers can generate an operation command by operating the human-machine interface (51). The third processing module (54) and the third wireless communication module (55) transmit the operation command to the floating barrel (4) via the second wireless communication module (45). According to the operation command, the second processing module (44) and the programmable control module (43) control amount of the gas via the second opening (47), so that the flow of the gas of the gas flow controller (41) is controlled, or the second processing module (44) and the programmable control module (43) control amount of the ocean water which flows in or out the receiving space of the floating barrel (4) via the first opening (40), so as to control the sinking or rising speed of the floating barrel (4). The marine environment monitoring system (5) can receive an acceleration signal via the third wireless communication module (55), and the acceleration signal is generated by the accelerometer (31) of the working platform (3) according to the moving state of the floating barrel (4) to make the fishery farmers monitor the acceleration signal of the floating barrel (4) through the marine environment monitoring system (5), and manipulates the human-machine interface (51) to control the movement state of the floating barrel (4), thereby adjusting and balancing the tilt angle of the cage net body (1000). In one embodiment of the present disclosure, the marine environment monitoring module (52) further comprises at least one of a wave sensor, a water temperature sensor, a water quality sensor, and a wind speed sensor. When practicing, each sensor monitors the waves, water temperature, water quality, and wind speed in the breeding region, and generates monitoring data of each sensor, and the monitoring data of each sensor is collected by the third processing module (54) and stored in the data storage module (53), or the wave, water temperature, water quality, and wind speed in the breeding region are browsed or analyzed by the human-machine interface (51). In other one embodiment of the present disclosure, the automatically sinking cage net system further comprises a cloud server. The cloud server, the first wireless communication module (33), the second wireless communication module (45) and the third wireless communication module (55) are signally connected to each other. When practicing, each sensor monitors the wave, water temperature, water quality and wind speed in the breeding region, and generates the monitoring data of the sensor. The third processing module (54) transmits the collected monitoring data of each sensor through the third wireless communication module (55), and the monitoring data is stored in the cloud server. The cloud server can be used by the fishery farmers to download and browse the monitoring data of the wave, water temperature, water quality and wind speed in the breeding region, which are generated by the sensors. In one embodiment of the present disclosure, the marine environment monitoring system (5) further comprises a data analysis module (56), and the human-machine interface (51) comprises a data analysis unit (514). When practicing, the marine environment monitoring module (52) collects a piece of monitoring data generated by the floating barrel (4) and the working platform (3) in the breeding region, and through the third processing module (54) and the data analysis module (56), the monitoring data passes is used to be calculated and analyzed to generate an analysis data, and the analysis data can be browsed by the data analysis unit (514) of the human-machine interface (51).

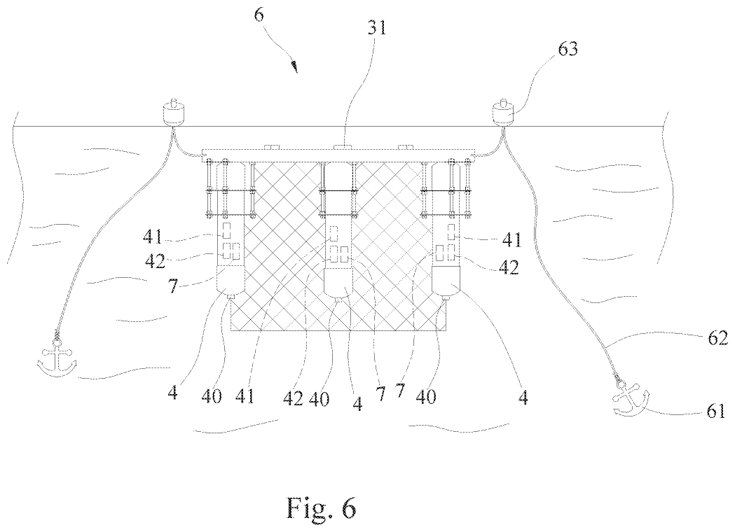

Refer to FIG. 6, and FIG. 6 is a first schematic diagram showing an automatically sinking cage net system according to one preferred embodiment of the present disclosure. The automatically sinking cage net system further comprises an anchor device (6), and the anchor device (6) comprises an anchor (61), a connection part (62) and a float (63). The anchor (61) can be exemplified but not limited to a cement block, an iron anchor or a cage bag. When practicing, the anchor device (6) is mainly used to fix the cage net body (1000) within the sea area planned by the fishery farmers, so as to prevent the cage net body (1000) from drifting out of the planned sea area affected by waves and currents. In one embodiment of the present disclosure, the connection part (62) is a cable or chain. When practicing, it is mainly eliminates the pulling action of waves or ocean currents on the anchor device (6), and specifically, the float (63) can oscillate up and down by buoyancy to eliminate the pulling action of waves and currents on the cage net body (1000).

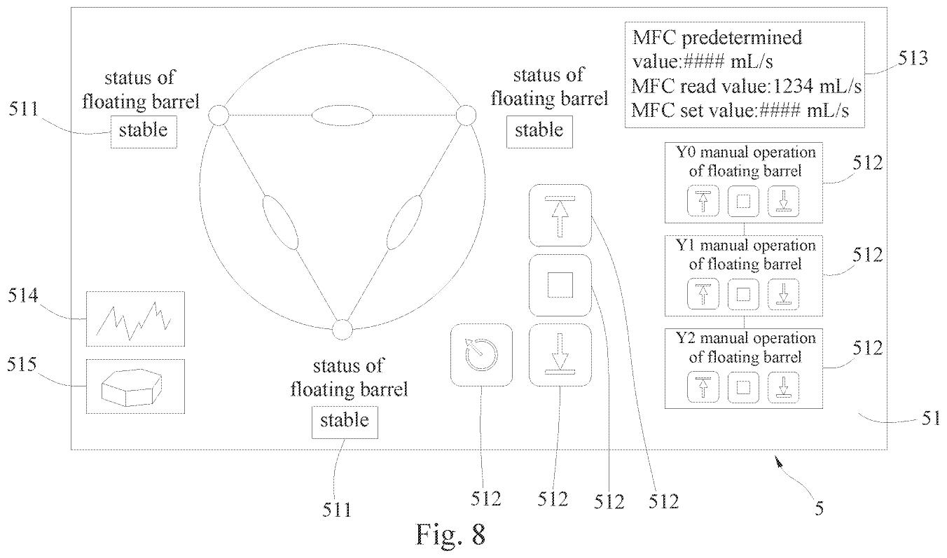

Refer to FIG. 8, and FIG. 8 is a schematic diagram showing a human-machine interface of an automatically sinking cage net system according to one preferred embodiment of the present disclosure. The marine environment monitoring system (5) comprises a human-machine interface (51), a marine environment monitoring module (52), a data storage module (53), a third processing module (54) and a third wireless communication module (55). In one embodiment of the present disclosure, the human-machine interface (51) comprises a floating barrel status unit (511), an operation unit (512) and a parameter setting unit (513). The fishery farmers can observe the floating barrel status unit (511) to understand the current operating status of the floating barrel (4); or, the fishery farmers can use the operation unit (512) to control the floating barrel (4) to rise, sink or maintain; or, the fishery farmers can set the parameter setting unit (513) to monitor the operating status of the floating barrel (4), or automatically adjust the operating status of the floating barrel (4).

In one embodiment of the present disclosure, exterior of the floating barrel (4) further comprises a camera device (7), and the human-machine interface (51) comprises an image unit (515), wherein the camera device (7), the gas flow controller (41), the water level sensor (42), the programmable control module (43), the second processing module (44) and the second wireless communication module (45) are electrically connected to each other. When practicing, the camera device (7) captures an image of a group of fish in the water, and the image of the fish group is converted into an image signal, and sent to the marine environment monitoring system (5) through the second processing module (44) and the second wireless communication module (45), so as to remotely observe the activity of the fish group.

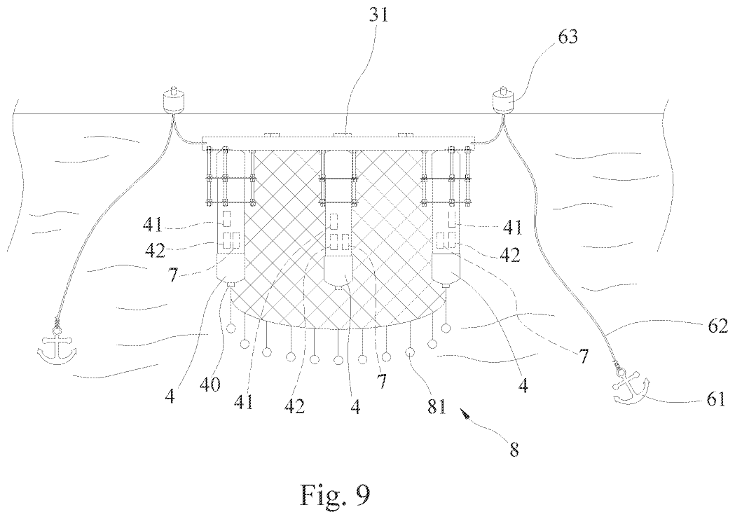

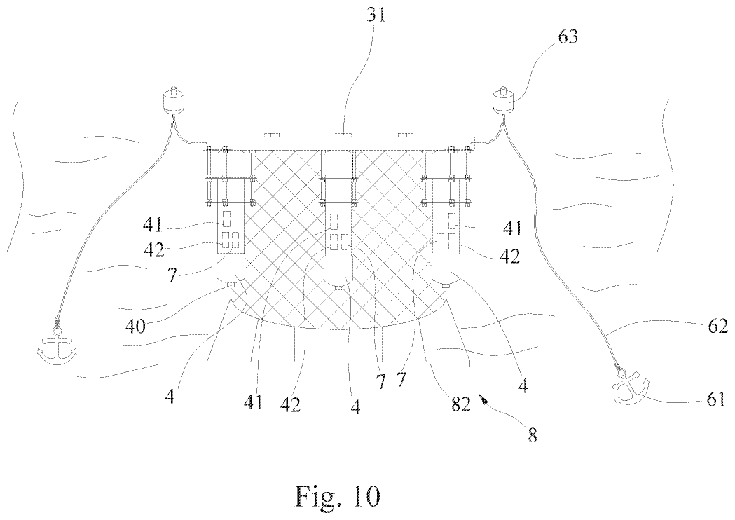

Refer to FIG. 9 and FIG. 10, FIG. 9 is a schematic diagram showing a heavy hammer counterweight structure of an automatically sinking cage net system according to one preferred embodiment of the present disclosure, and FIG. 10 is a schematic diagram showing a net frame counterweight structure of an automatically sinking cage net system according to one preferred embodiment of the present disclosure. The automatically sinking cage net system further comprises a counterweight system (8), and the counterweight system (8) is disposed on another one side of the net body (2) opposite to the floating frame (1). The counterweight system (8) is selected one of a heavy hammer counterweight structure (81) and a net frame counterweight structure (82). When practicing, the counterweight system (8) is mainly used to maintain the volume ratio of the net body (2), so as to keep the set breeding density. When the deformation rate of the net body (2) is too large, it will cause the fish to panic and collide with each other or the mesh bag, and the fishes may will be injured and died.

In summary, compared with the prior art and products, the present disclosure has one of the following advantages.

One of the objectives of the present disclosure is to use an automatically sinking cage net system to greatly reduce the manpower and time required to perform the sinking action of the cage net body and reduce personnel safety problems caused by manual operations.

One of the objectives of the present disclosure is to detect the tilt angle of the floating frame by an accelerometer, and adjust and reduce the tilt angle range of the floating frame, so as to prevent the floating frame from having have an excessively large tilt angle when the cage net body sinks, which causes the net body volume rapidly decrease, injures the farmed fish, and even makes the farmed first death.

One of the objectives of the present disclosure is to provide monitoring data of various sensors such as water temperature, wave, water quality, and wind speed in accordance with the marine environment monitoring system, so that the fishery farmers can judge the timing when the body sinks or rises to greatly reduce the loss of the fishery farmers if the sudden natural disasters or accidents happen.

One of the objectives of the present disclosure is to use simple and clear floating barrel status unit, operation unit and parameter setting unit through the human-machine interface of the marine environment monitoring system to simplify the operation interface and make the fishery farmers more quickly familiar the system commands to operate the floating barrel to drive the cage net body to sink or rise.

One of the objectives of the present disclosure is to set a propeller on the floating barrel to control the sinking or rising speed of the cage net body, so as to cope with various sudden situations at any time.

To sum up, the automatically sinking cage net system of the present disclosure is indeed disclosed by the descriptions of different embodiments, and it can achieve the desired result(s). Furthermore, the automatically sinking cage net system of the present disclosure is not anticipated and obtained by the prior art, and the present disclosure complies with the provision of the patent act. The present disclosure is applied according to the patent act, and the examination and allowance requests are solicited respectfully.

Although particular embodiments of the present disclosure have been described in detail for purposes of illustration, various modifications and enhancements may be made without departing from the spirit and scope of the present disclosure. Accordingly, the present disclosure is not to be limited except as by the appended claims.

What is claimed is:

1. An automatically sinking cage net system, comprising:
a cage net body comprising a floating frame and a net body, the net body surrounds a lower end of the floating frame, and the net body surrounds to form breeding space;
a working platform comprising an accelerometer, a first processing module and a first wireless communication module, the working platform is disposed on an upper end of the floating frame, and the accelerometer, the first processing module and the first wireless communication module are electrically connected to each other;
a floating barrel at least comprising an first opening, a gas flow controller, a water level sensor, a programmable control module, a second processing module, a second wireless communication module and a second opening, interior of the floating barrel has a receiving space, the receiving space is communicated with the first opening and the second opening, the floating barrel is disposed on a lower end of the floating frame and outside the breeding space, the first opening is disposed on one side of the floating barrel, the second opening is disposed on another one side of the floating barrel which is opposite to the first opening, and the gas flow controller, the water level sensor, the programmable control module, the second processing module and the second wireless communication module are electrically connected to each other; and
a marine environment monitoring system comprising a human-machine interface, a marine environment monitoring module, a data storage module, a third processing module and a third wireless communication module, the human-machine interface, the marine environment monitoring module, the data storage module, the third processing module and the third wireless communication module are electrically connected to each other, and the first wireless communication module, the second wireless communication module and the third wireless communication module are signally connected to each other.

2. The automatically sinking cage net system according to claim 1, wherein the floating frame further has a floating tube surrounding the floating frame, the floating tube forms a ring structure, and interior of the floating tube has a hollow receiving space.

3. The automatically sinking cage net system according to claim 1, wherein an upper end of the floating frame has an armrest.

4. The automatically sinking cage net system according to claim 1, wherein exterior of the floating barrel further has a propeller.

5. The automatically sinking cage net system according to claim 1, further comprising an anchor device which includes an anchor, a connection part and a float.

6. The automatically sinking cage net system according to claim 5, wherein the connection part is a cable or chain.

7. The automatically sinking cage net system according to claim 1, wherein the gas flow controller is a thermal gas mass flow controller.

8. The automatically sinking cage net system according to claim 1, wherein the water level sensor is a water pressure sensor.

9. The automatically sinking cage net system according to claim 1, wherein the marine environment monitoring module further comprises at least one of a wave sensor, a water temperature sensor, a water quality sensor, and a wind speed sensor.

10. The automatically sinking cage net system according to claim 1, wherein the human-machine interface comprises a floating barrel status unit, an operation unit and a parameter setting unit.

11. The automatically sinking cage net system according to claim 1, further comprising a cloud server.

12. The automatically sinking cage net system according to claim 1, wherein the marine environment monitoring system further comprises a data analysis module, and the human-machine interface comprises a data analysis unit.

13. The automatically sinking cage net system according to claim 1, wherein exterior of the floating barrel further has a camera device, and the human-machine interface comprises an image unit.

14. The automatically sinking cage net system according to claim 1, further comprising a counterweight system, and the counterweight system is disposed on another one side of the net body opposite to the floating frame.

15. The automatically sinking cage net system according to claim 14, wherein the counterweight system is selected one of a heavy hammer counterweight structure and a net frame counterweight structure.
